(19) United States
(12) Patent Application Publication
(10) Pub. No.: US 2020/0168086 A1
(43) Pub. Date: May 28, 2020

(54) COMMUNICATION WITH VEHICLE IN AREA WHERE COMMUNICATION NETWORK IS NOT AVAILABLE

(71) Applicant: International Business Machines Corporation, Armonk, NY (US)

(72) Inventors: Sarbajit K. Rakshit, Kolkata (IN); John M. Ganci, JR., Raleigh, NC (US); James E. Bostick, Cedar Park, TX (US); Martin G. Keen, Cary, NC (US)

(21) Appl. No.: 16/200,059

(22) Filed: Nov. 26, 2018

(51) Int. Cl. G08G 1/0968; G08G 1/0967; H04W 4/46; H04W 36/30

(52) U.S. Cl. CPC G08G 1/096822; H04W 36/305; H04W 4/46; G08G 1/096775

(57) ABSTRACT

In some examples, a method includes determining, by a computing system, that a first vehicle is in an area where a first communication network is not available to the first vehicle. The method also includes determining, by the computing system, that a second vehicle is connected to the first communication network. The method further includes determining, by the computing system, that the second vehicle is or will be connected to the first vehicle by a second communication network. The method includes transmitting, by a transmitter coupled to the computing system, data through the first communication network to the second vehicle with instructions for the second vehicle to transmit the data to the first vehicle through the second communication network.

### TECHNICAL FIELD

This disclosure relates to communication between vehicles and communication between vehicles and remote systems.

### BACKGROUND

A navigation system onboard a vehicle can use network connectivity to receive route information from a central management system. The navigation system can also transmit information indicating the location, direction of travel, route, and destination to the central management system. The central management system can transmit instructions to the vehicle through a cellular network. The instructions may include new or modified routes, destinations, departure times and arrival times, speeds, and/or other parameters.

### SUMMARY

This disclosure describes techniques for communicating between a computing system and a first vehicle in examples in which the first vehicle is located in an area where a first communication network is not available to the first vehicle. The computing system can determine that a second vehicle is connected to the first communication network. The computing system can also determine that the second vehicle is or will be connected to the first vehicle by a second communication network. A transmitter coupled to the computing system may then transmit data through the first communication network to the second vehicle with instructions for the second vehicle to transmit the data to the first vehicle through the second communication network.

In one example, this disclosure describes a method including determining, by a computing system, that a first vehicle is in an area where a first communication network is not available to the first vehicle. The method also includes determining, by the computing system, that a second vehicle is connected to the first communication network. The method further includes determining, by the computing system, that the second vehicle is or will be connected to the first vehicle by a second communication network. The method includes transmitting, by a transmitter coupled to the computing system, data through the first communication network to the second vehicle with instructions for the second vehicle to transmit the data to the first vehicle through the second communication network.

In some examples, a system include a transmitter and processing circuitry configured to determine that a first vehicle is in an area where a first communication network is not available to the first vehicle. The processing circuitry is also configured to determine that a second vehicle is connected to the first communication network and determine that the second vehicle is or will be connected to the first vehicle by a second communication network. The processing circuitry is further configured to cause the transmitter to transmit data to the second vehicle through the first communication network with instructions for the second vehicle to transmit the data to the first vehicle through the second communication network.

In some examples, a computer-readable medium includes instructions for causing at least one programmable processor of a computing device to determine that a first vehicle is in an area where a first communication network is not available to the first vehicle. The computer-readable medium further includes instructions to determine that a second vehicle is connected to the first communication network and instructions to determine that the second vehicle is or will be connected to the first vehicle by a second communication network. The computer-readable medium also includes instructions to cause a transmitter to transmit data to the second vehicle through the first communication network with instructions for the second vehicle to transmit the data to the first vehicle through the second communication network.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram of a central management system transmitting data to a vehicle through an intermediary vehicle, in some examples of this disclosure.

FIG. 2 is a conceptual block diagram of a vehicle and a central management system, in some examples of this disclosure.

FIGS. 3 and 4 are conceptual block diagrams of vehicles traveling on a road, in some examples of this disclosure.

FIG. 5 is a conceptual block diagram of a vehicle with two possible routes to a destination, in some examples of this disclosure.

FIG. 6 shows a flowchart for an example technique for transmitting to a vehicle in an area where a communication network is not available, in some examples of this disclosure.

FIG. 7 shows a flowchart for an example technique for determining a route for an autonomous vehicle, in some examples of this disclosure.

FIG. 8 shows a flowchart for an example technique for transmitting from a vehicle in an area where a communication network is not available to a remote computing system, in some examples of this disclosure.

### DETAILED DESCRIPTION

This disclosure describes using vehicle to vehicle (V2V) communication (e.g., a second communication network) as an intermediary when a first communication network is not available. In some examples, V2V communication is a fallback option when a cellular communication network (e.g., a first communication network) is not available to a first vehicle. A central management system can transmit instructions to a second vehicle that still has cellular service and that is approaching the first vehicle. The second vehicle can in turn use V2V to transmit instructions to the first vehicle such as when the first vehicle is located within a cellular network outage roadway segment (e.g., a segment where the first vehicle is not connected to the cellular communication network).

In addition, the first vehicle can use V2V communication to communicate with a second vehicle traveling in the opposite traffic direction. The second vehicle can later communicate with the central management system when the second vehicle leaves the outage area and regains cellular connectivity.

The techniques of this disclosure make use of V2V communication networks to increase the effective range of other communication networks, such as cellular networks. The usage of V2V communication networks described herein may effectively reduce the latency or delay in communicating between a vehicle and a remote computing system. These communication techniques can effectively shrink an outage area and/or reduce the effects of the outage area experienced by a vehicle. The techniques may also increase the efficiency of an autonomous vehicle fleet by allowing quicker route changes and faster communication between a management system and vehicles in the fleet.

There are several methods for inputting and controlling the navigation of autonomous vehicles. A passenger of an autonomous vehicle can input a destination into the autonomous vehicle, and in turn the autonomous vehicle system will map and navigate a route to the destination. Remote management can be used to control the destinations, routes, and operation of autonomous vehicles. For example, a central management system can transmit instructions to the autonomous vehicle with a destination and/or a route to navigate. Remote management of the autonomous vehicle may rely upon cellular network connectivity or other network connectivity to monitor and control the operation of an autonomous vehicle.

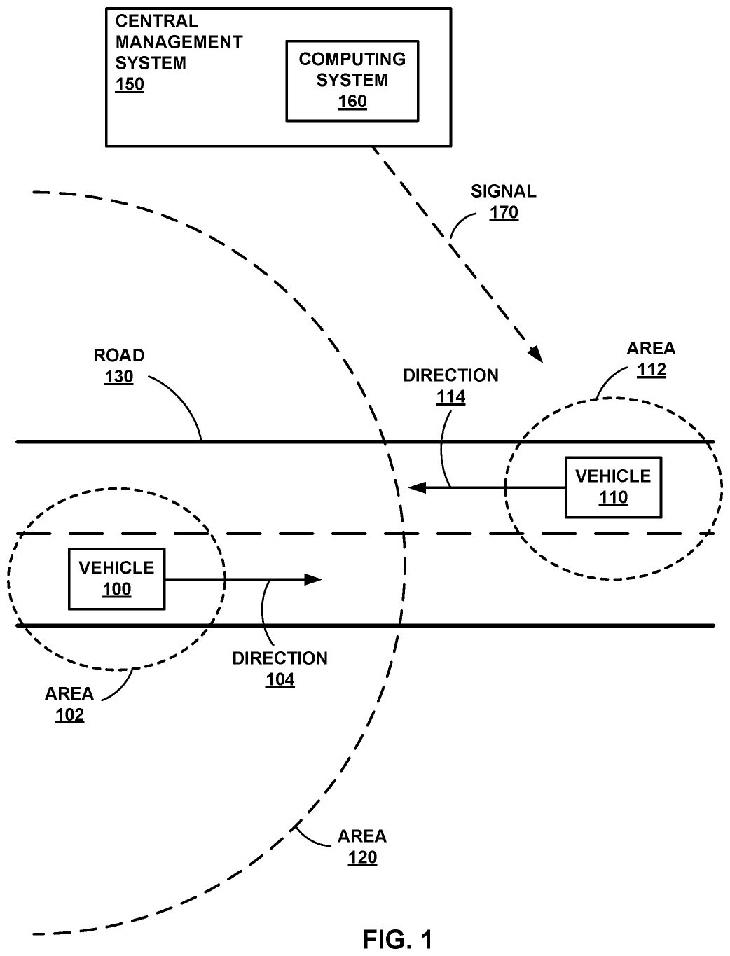

FIG. 1 is a conceptual block diagram of a central management system 150 transmitting data to a vehicle 100 through an intermediary vehicle 110, in some examples of this disclosure. Central management system 150 may be configured to manage and provide inputs to vehicles 100 and 110 from a remote location through a first communication network, such as a cellular network, a radio frequency (RF) network, a long-range Wi-Fi network, and/or any other wireless communication network. In the example of FIG. 1, vehicles 100 and 110 may be configured to communicate through a second communication network, which allow V2V communication. The second communication network may include a Bluetooth network, an infrared communication network, a Wi-Fi network, an RF network, and/or any other wireless communication network.

Communication between system 150 and vehicle 100 may not function properly when the navigation path of vehicle 100 passes through area 120, which has unreliable or no connectivity to the first communication network. Area 120 defines an area where no signals are available from the first communication network. As one example, weather-related issues may impact the cellular connectivity in area 120. There may be other causes for why no signals are available from the first communication network including due to relatively long distance to a communication tower, signal interference from external sources, etc. Even when outside of area 120, vehicle 100 can lose connection with the first communication network due to an electrical or mechanical problem on vehicle 100, such as damage to an antenna or to a connection with the antenna.

Area 120 is an area where a first communication network is not available to vehicle 100. Area 120 may be a geographical area in which no signal is available from the first communication network. For example, there may not be any cellular transmission towers near area 120, or the terrain around area 120 may block the transmission of cellular signals. The first communication network may not be available to vehicle 100 in area 120 because of inclement weather conditions. In some examples, vehicle 100 may not have a connection to the first communication network even outside of area 120 due to mechanical or electrical issues with a transceiver onboard vehicle 100.

Vehicles 100 and 110 may be any mobile object or remote object with access to one or more communication networks. In some examples, vehicles 100 and/or 110 may be an aircraft such as a helicopter or a weather balloon, or vehicles 100 and/or 110 may be a space vehicle such as a satellite or spaceship. In yet other examples, vehicles 100 and/or 110 may include a land vehicle such as an automobile or a water vehicle such as a ship or a submarine. Vehicles 100 and/or 110 may be a manned vehicle or an unmanned vehicle, such as an autonomous vehicle, a drone, a remote-control vehicle, or any suitable vehicle without any pilot or crew on board. Vehicle 100 may be referred to as the “target vehicle,” and vehicle 110 may be referred to as the “intermediary vehicle.”

Each of vehicles 100 and 110 may include one or more transceivers and processing circuitry. For example, vehicle 100 can include a first transceiver for the first communication network and a second transceiver for the second communication network. Additionally or alternatively, vehicle 100 can include a multi-purpose transceiver for both the first and second communication networks. The processing circuitry onboard vehicles 100 and 110 may be configured to encode and decode communication signals transmitted and received by vehicles 100 and 110. The processing circuitry may also be able to control the operation of the transceivers to transmit data through the second communication network when another vehicle is within range. The processing circuitry can also control movement of vehicles 100 and 110 based on instructions received from central management system 150.

Vehicle 100 is traveling in direction 104 on road 130. Vehicle 110 is traveling in direction 114 on road 130, where direction 114 is opposite to direction 104. Thus, vehicles 100 and 110 are traveling in opposite direction towards each other on road 130. In some examples, vehicles 100 and 110 may be traveling on different roads but towards each other. Computing system 160 can determine that vehicles 100 and 110 will be able to communicate through the second communication network based on data indicating the locations, routes, and/or destinations of vehicles 100 and 110.

Vehicle 100 is surrounded by area 102, and vehicle 110 is surrounded by area 112. Each of areas 102 and 112 represents the range of a second communication network. Thus, vehicle 100 may be able to communicate via the second communication network within area 102, and vehicle 110 may be able to communicate via the second communication network within area 112. The range of the second communication network, shown by areas 102 and 112, may be shorter than the range of the first communication network. Area 102 may move with vehicle 100 as vehicle 100 moves, and area 112 may move with vehicle 110 as vehicle 110 moves. Area 120, in contrast, may not move as vehicles 100 and 110 move.

In the example of FIG. 1, vehicle 110 is not located in area 120. Vehicle 110 is connected to the first communication network because vehicle 110 is not located in area 120 where the first communication network may not be available. Thus, vehicle 110 and central management system 150 can communicate via the first communication network. Signal 170 transmitted by computing system 160 is an example of a communication using the first communication network.

Road 130 is an example of a path over which vehicles 100 and 110 can travel. Road 130 may be a public road or a private road, and may include pavement or concrete or may be unpaved. In some examples, vehicles 100 are 110 are aircraft and can travel in directions 104 and 114 without road 130. Computing system 160 may be configured to determine that vehicles 100 and 110 are traveling in opposite directions 104 and 114 regardless of whether vehicles 100 and 110 are traveling on a fixed roadway.

Central management system 150 includes computing system 160. Central management system 150 may be configured to transmit signal 170 using the first communication network. Central management system 150 may include a cloud server, vehicle management hub, a cellular transmission tower, and/or any other infrastructure. Central management system 150 may be an application hosted within a cloud computing environment. Central management system 150 can include an application running on a server that has connectivity with vehicles 100 and 110 through communication such as Internet. Central management system 150 may be a fleet management system configured to manage a fleet of delivery vehicles, a fleet of public transit vehicles, a fleet of aircraft, a fleet of vehicles for hire (e.g., taxis), and/or any other fleet of vehicles. Central management system 150 may also be a vehicle manufacturer system or a navigation service that monitors and communicates with vehicles that are subscribers.

Central management system 150 can centrally manage roadways to coordinate how autonomous vehicles traverse the roadways. With autonomous vehicles there is no driver so another entity can manage the operation of the vehicle. Central management of autonomous vehicles is already occurring at limited or test scales. For example, an autonomous delivery service vehicle can deliver packages but has to be routed to various destinations by central management system 150. Central management system 150 will be in communication with the vehicles to provide routes for the delivery of packages.

Fleet vehicles can be fitted with tracking and communication devices. The category of “fleet vehicles” includes United Parcel Service of America (UPS) based in Atlanta, Ga. and FedEx Corporation based in Memphis, Tenn. Central management system 150 may be able to track the location of each vehicle and packages as the vehicle moves around using GPS or another location awareness device. The insurance industry makes use of adding devices to vehicles to track things like vehicle speed, location, and other parameters. Central management system 150 can receive the information and parameters of the vehicle. In cases of delivery, central management system 150 may send new routes to the vehicle.

Signal 170 may include data and instructions to vehicle 110 to transmit the data to vehicle 100 through the second communication network. The data may include a new route for vehicle 100, a new or additional destination for vehicle 100, delivery instructions for vehicle 100, information relating to the status of vehicle 100, and/or a request for information from vehicle 100. Vehicle 110 may be configured to determine when vehicle 100 is within area 112 (e.g., within range for the second communication network) and transmit the data to vehicle 100 responsive to determining that vehicle 100 is within area 112.

Computing system 160 may be configured to determine that vehicle 100 is in area 120 where a first communication network is not available to vehicle 100. To make this determination, computing system 160 can determine the boundaries of area 120 and then determine that vehicle 100 is inside area 120. Computing system 160 may be configured to determine, before vehicle 100 enters area 120, that vehicle 100 is traveling towards area 120 based on signals received from vehicle 100 through the first communication network. Additionally or alternatively, computing system 160 can determine that the first communication network is not available to vehicle 100 by causing a transmitter to transmit a signal to vehicle 100 through the first communication network and determining that vehicle 100 did not respond to the signal by transmitting back to computing system 160.

Computing system 160 can determine the location and direction of vehicle 100 in area 120 even though vehicle 100 cannot communicate this information to computing system 160. For example, computing system 160 may have stored the starting point, route, destination, time of departure, and time of arrival. Computing system 160 may also have received updates on the location and direction of travel from vehicle 100 before vehicle 100 entered area 120. Computing system 160 can use this information to determine or estimate the current location and direction of travel of vehicle 100 while vehicle 100 is traveling through area 120.

In examples in which vehicle 100 is an autonomous vehicle, vehicle 100 may have already received a navigation path and the stored the navigation path to a memory onboard vehicle 100. Vehicle 100 can navigate the stored path during the loss of network connectivity. However, during the loss of network connectivity, vehicle 100 may not be able to directly receive a new or modified navigation path from central management system 150.

Computing system 160 may be configured to determine that vehicle 110 is connected to the first communication network. To make this determination, computing system 160 can determine the boundaries of area 120, where the first communication network is not available to vehicle 100, and then determine that vehicle 110 is not inside area 120. Computing system 160 may be configured to determine that vehicle 110 is also not in any other area where the first communication network is not available. Additionally or alternatively, computing system 160 can determine that vehicle 110 is connected to the first communication network by causing a transmitter to transmit a signal to vehicle 110 through the first communication network and determining that vehicle 110 responds to the signal by transmitting back to computing system 160.

Computing system 160 may be configured to determine that vehicle 110 is or will be connected to vehicle 100 by the second communication network. In the example of FIG. 1, vehicles 100 and 110 are not currently connected by the second communication network, but vehicles 100 and 110 will be connected by the second communication network when vehicle 100 is inside area 112 and vehicle 110 is inside area 102. Computing system 160 may determine that vehicles 100 and 110 are connected by the second communication network if computing system 160 receives a communication from vehicle 110 indicating that vehicles 100 and 110 are connected by the second communication network. Computing system 160 may determine that vehicles 100 and 110 will be connected by the second communication network in the future by determining that vehicles 100 and 110 are traveling in opposite directions 104 and 114 towards each other (e.g., based on route information).

Computing system 160 can communicate with vehicles 100 and 110 regarding the travel paths (e.g., routes), destinations, and other operating parameters of vehicles 100 and 110. Vehicles 100 and 110 may be configured to transmit data indicating the locations of vehicles 100 and 110 to computing system 160 when the first communication network is available to the respective vehicle. When the first communication network is not available to vehicle 100, vehicle 100 can transmit data to other vehicles, such as vehicle 110, for transmission through the first communication network to computing system 160.

Computing system 160 may be configured to cause a transmitter to transmit signal 170 to vehicle 110, where signal 170 includes data and instructions to vehicle 110 to transmit the data to vehicle 100 through the second communication network. Vehicle 110 can store the data to a memory device and transmit the data to vehicle 100 when vehicles 100 and 110 are in range of communicating by the second communication network. Vehicle 110 can then deliver the data to vehicle when vehicles 100 and 110 are in range of the second communication network, even if both of vehicles 100 and 110 are located in area 120 where the first communication network is not available.

The techniques of this disclosure may enable computing system 160 to communicate with vehicle 100 more quickly, as compared to waiting until vehicle 100 leaves area 120. In examples in which vehicle 100 has a mechanical or electrical problem that prevents usage of the first communication network even outside of area 120, computing system 160 can communicate with vehicle 100 by causing a transmitter to transmit signal 170 to vehicle 110.

The communication techniques described herein can be used with centralized management of autonomous vehicles. The communication techniques can also be used with traditional, non-autonomous vehicles and/or with noncentralized communication with vehicles. This disclosure describes cellular communication as an example of a first communication network and V2V communication as an example of a second communication network. However, the first or second communication network may include another possible communication networks, such as such as cellular, Wi-Fi, Bluetooth, Zigbee, infrared, near field communication, radio frequency, and/or microwave signals. V2V communication can include any of these communication protocols used between vehicles 100 and 110.

Communication using the second communication network may be a part of a personal area network (PAN). PAN can be used to communicate between local computers or internet of things (IoT) devices that can be mounted on or fitted in vehicle 100 or 110. Examples of PAN include Bluetooth, Wi-Fi, Zigbee, and infrared data association.

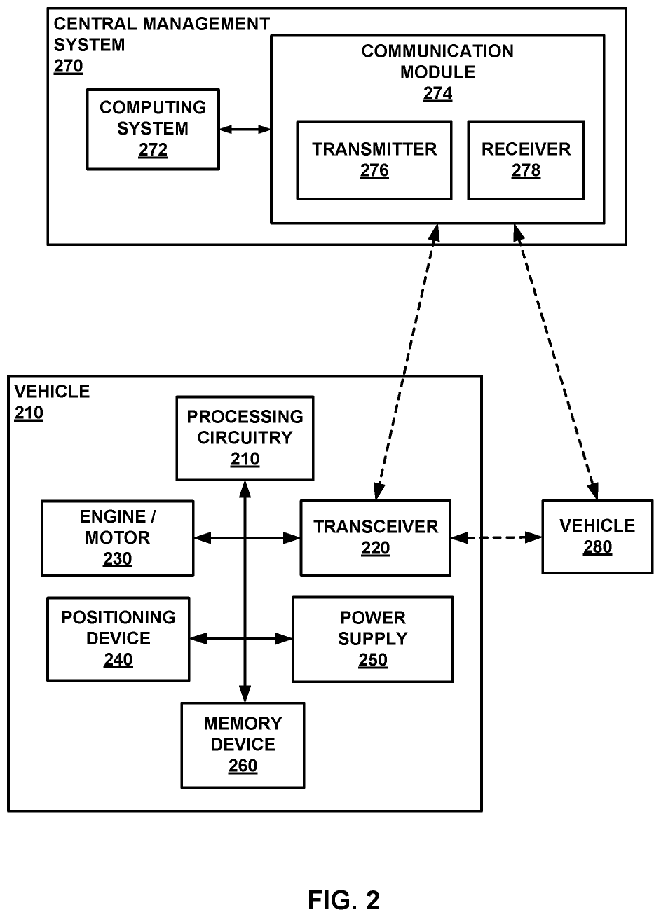

FIG. 2 is a conceptual block diagram of a vehicle 200 and a central management system 270, in some examples of this disclosure. Vehicle 200 includes processing circuitry 210, transceiver 220, engine or motor 230, positioning device 240, power supply 250, and memory device 260.

Processing circuitry 210 may be configured to encode signals for transmission by transceiver 220. For example, processing circuitry 210 can cause transceiver 220 to transmit data indicating the location, route, destination, fuel level, engine operating parameters, and/or any other operating parameters to communication module 274 of central management system 270 or vehicle 280. Processing circuitry can cause transceiver 220 to transmit data to vehicle 280 with instructions to transmit the data to central management system 270 when vehicle 280 establishes a connection with central management system 270 through the first communication network.

Processing circuitry 210 may also be configured to decode signals received by transceiver 220. Transceiver 220 may receive signals indicating a new route or destination for vehicle 200 from central management system 270, either directly or through vehicle 280. Transceiver 220 can also receive data from vehicle 280 with instructions for vehicle 200 to transmit the data to central management system 270 when transceiver establishes a connection with central management system 270 through the first communication network.

Transceiver 220 may include one or more antenna for communicating with remote objects through one or more communication networks. In some examples, transceiver 220 includes a cellular module for communicating with communication module 274 of central management system 270 through the first communication network. Transceiver 220 can also include a Wi-Fi module, a Bluetooth module, and/or any other wireless module for communicating through a second communication network.

Processing circuitry 210 may be configured to control the movements of vehicle 200 by controlling the operation of engine or motor 230, as well as the brakes on vehicle 200. Processing circuitry 210 may control the movement of vehicle 200 based on the route and destination stored to memory device 260. Processing circuitry 210 may control the movement of vehicle 200 further based on data received from sensors mounted on vehicle 200. Processing circuitry 210 may include an engine control unit and any other processing circuitry for controlling engine or motor 230.

Positioning device 240 may be configured to determine the location of vehicle 200. Processing circuitry 210 can store the location to memory device 260 and/or transmit the location to central management system 270 and/or vehicle 280 via transceiver 220.

Power supply 250 may be configured to provide electrical power to processing circuitry 210, transceiver 220, positioning device 240, and memory device 260. Power supply 260 may include a rechargeable battery. In examples in which vehicle 200 includes engine 230, power supply 260 may also include an alternator configured to generate electricity based on the energy produced by engine 230. In examples in which vehicle 200 includes motor 230, a battery of power supply 260 can deliver electrical power to motor 230.

Memory device 260 is configured to store data received from processing circuitry 210, transceiver 220, or positioning device 240. Memory device 260 can store the starting point, route, and destination of vehicle 200. Memory device 260 can also store the location of vehicle 200, as well as the location of outage areas where the first communication network is not available.

Central management system 270 may include computing system 272 and communication module 274. Communication module 274 may be configured to encode signals for transmission by transmitter 276. For example, communication module 274 can cause transmitter 276 to transmit data indicating a routes, destinations, departure times, arrival times, and/or any other travel parameters to transceiver 220 onboard vehicle 200 or to vehicle 280. Processing circuitry can cause transceiver 220 to transmit data to vehicle 280 with instructions to transmit the data to central management system 270 when vehicle 280 establishes a connection with central management system 270 through the first communication network.

Communication module 274 may also be configured to decode signals received by receiver 278. Receiver 278 may receive signals indicating a location, route, or destination for vehicle 200, either directly from transceiver 220 onboard vehicle 200 or through vehicle 280. Receiver 278 may receive signals indicating a location, route, or destination for vehicle 280, either directly from vehicle 280 or through vehicle 200.

Communication module 274 may include one or more antenna for communicating with remote objects through one or more communication networks. In some examples, communication module 274 includes a cellular module for communicating with transceiver 220 of vehicle 200 through the first communication network. Communication module 274 can also include a Wi-Fi module, a Bluetooth module, and/or any other wireless module for communicating through a second communication network.

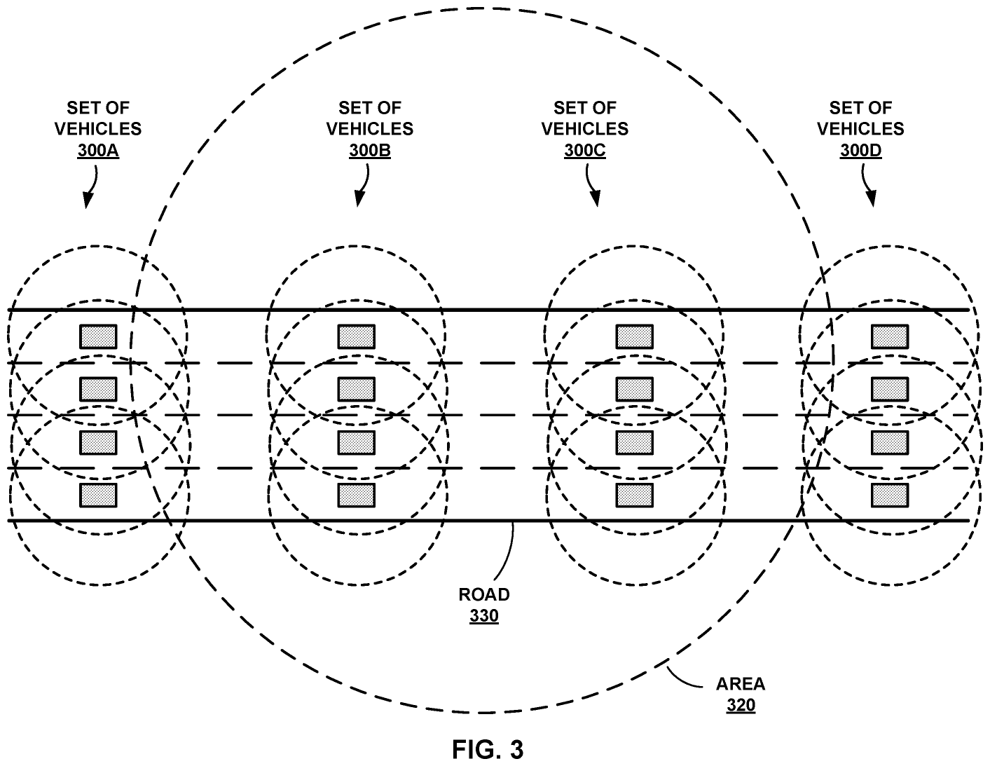

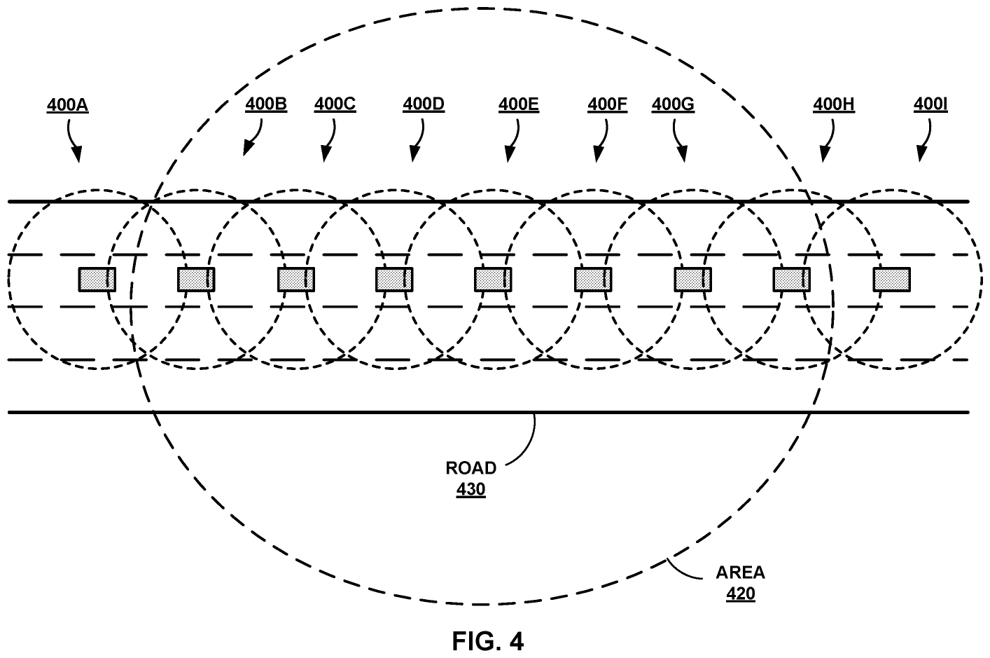

FIGS. 3 and 4 are conceptual block diagrams of vehicles traveling on a road, in some examples of this disclosure. In the example of FIG. 3, sets of vehicles 300A-300D are traveling on road 330 in the same direction in four lanes. Sets of vehicles 300B and 300C are located inside of area 320 where a first communication network is not available to sets of vehicles 300B and 300C. Sets of vehicles 300A and 300D are located outside of area 320.

Outside of area 320, the first communication network is available for the vehicles to communicate with a central management system (e.g., central management system 150 shown in FIG. 1). Inside of area 320, there is a network outage where only V2V communication may be possible. The central management system 150 may be able to predict or determine the existence and location of area 320. The central management system can also transmit travel management instructions to a vehicle traveling in the opposite direction of a target vehicle ahead of area 320 such that V2V data exchange can occur when within proximity of the target vehicle. Communication from the target vehicle can be achieved by V2V communication, and an intermediary vehicle outside of area 320 can transmit the data from the target vehicle to the central management system once the intermediary vehicle has a connection to the first communication network.

Therefore, sets of vehicles 300A and 300D can receive data and instructions from a central management system. A central management system may transmit instructions to a vehicle of sets of vehicles 300A and 300D, where the instructions are for the vehicle to transmit data to a vehicle of sets of vehicles 300B and 300C. However, because of the spacing of sets of vehicles 300A-300D and the limited range of the second communication network, a vehicle of set of vehicles 300A cannot transmit to a vehicle of sets of vehicles 300B or 300C. Thus, the central management system may instruct the vehicles to reposition in a single-file arrangement, as shown in FIG. 4, to allow for V2V communication through the second communication network.

In the example of FIG. 4, vehicles 400A-4001 are traveling on road 430 in the same direction in a single lane so that each pair of vehicles is proximate with each other and can create a V2V network. Vehicles 400B-400H are located inside of area 420 where a first communication network is not available to vehicles 400B-400H. Vehicles 400A and 4001 are located outside of area 420 and can receive data and instructions from a central management system. A central management system may transmit instructions to vehicle 400A or 4001, where the instructions are for vehicle 400A or 4001 to transmit data to one of vehicles 400B-400H. Because the spacing between vehicles 400A-4001 is sufficiently small, vehicles 400A-4001 can communicate down the line of vehicles 400A-4001 through the second communication network. Thus, the V2V communication between vehicles 400A-4001 through the second communication network may allow the central management system to effectively communicate with any of vehicles 400A-4001. Any of vehicles 400A-4001 can communicate with a remote server through seamless V2V connectivity using the second communication network.

For example, the central management system can determine that vehicle 400C is connected to vehicle 400A by the second communication network. The central management system may determine that vehicle 400A is connected to vehicle 400B by the second communication network, wherein vehicle 400B is located between vehicles 400A and 400C. The central management system may also determine that vehicle 400B is connected to vehicle 400C by the second communication network. Further, the central management system may determine that each of vehicles 400A-400C is traveling on road 430 in the same direction. Thus, even though the first communication network is not available to vehicles 400B and 400C, the central management system can communicate with vehicles 400B and 400C by communicating with vehicle 400A.

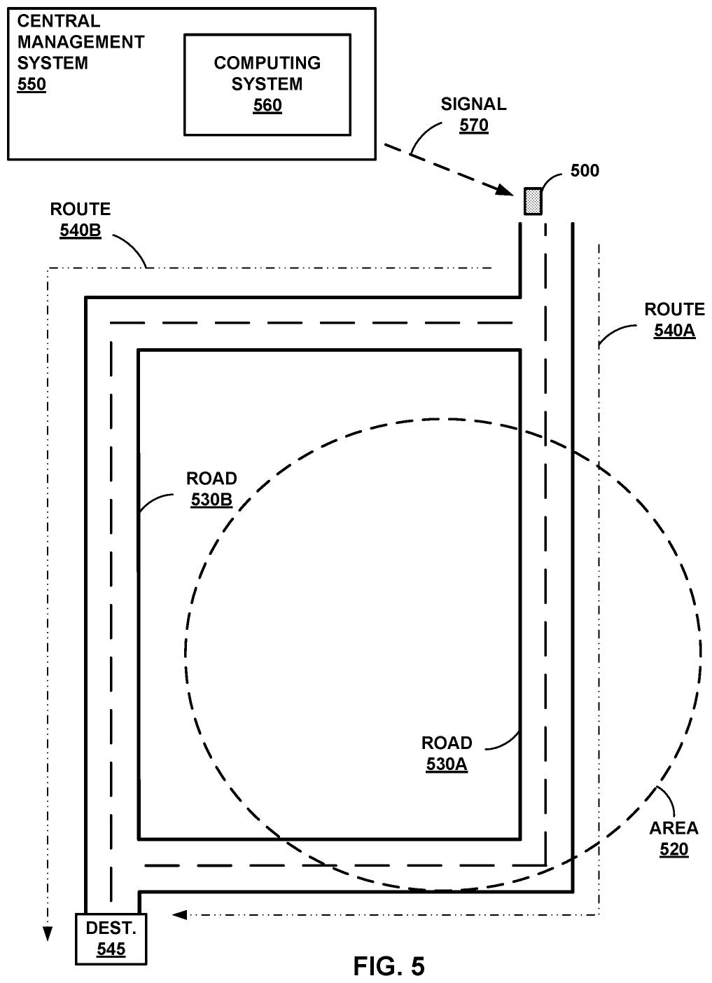

FIG. 5 is a conceptual block diagram of a vehicle 500 with two possible routes 540A and 540B to a destination 545, in some examples of this disclosure. Computing system 560 of central management system 550 may be configured to predict a network outage in area 520 in along the travel path of vehicle 500. The first communication network may not be available to vehicle 500 within area 520.

Computing system 560 may determine that vehicle 500 can travel to destination 545 using either route 540A along road 530A or route 540B along road 530B. Computing system 560 can determine that the first communication network will not be available to vehicle 500 inside area 520, which partially overlaps with route 540A. Computing system 560 can also determine that the first communication network will be available to vehicle 500 along route 540B because area 520 does not overlap with route 540B.

Responsive to determining that route 540A includes area 520 and route 540B does not include area 520, computing system 560 can select route 540B for vehicle 500. Computing system 560 may be configured to cause a transmitter to transmit signal 570 to vehicle 500 with instructions to travel on route 540B. To select a route for vehicle 500, computing system 560 may also use an estimated number of vehicles traveling along each route in the opposite direction of vehicle 500. Computing system 560 may consider how many of the estimated number of vehicles will have the capability to communicate with vehicle 500 through the second communication network. In some examples, computing system 560 determines if enough autonomous vehicles will be traveling on road 530A or 530B for time of travel in the cellular network outage roadway segment (e.g., area 520) to use V2V communication and to communicate with computing system 560 when the vehicles return to the cellular network area outside of area 520.

The following description is an example of communication between computing system 560 and vehicle 500. Central management system 550 may define the travel route of vehicle 500. Before vehicle 500 begins the traveling, computing system 560 cause a transmitter to transmit signal 570 to vehicle 500 with instructions for vehicle 500 to travel along route 540A and use the first communication network to communicate with computing system 560 during travel. For example, vehicle 500 may be a delivery autonomous vehicle. Vehicle 500 receives signal 570 including instructions to travel on route 540A and begins the travel path along route 540A.

While vehicle 500 travels along route 540A, computing system 560 may have the ability to change the travel path of vehicle 500 in response to determining the existence and/or location of area 520 along route 540A. Computing system 560 can evaluate route 540A to predict network outage roadway segments based on cellular network map availability. Central management system 560 may determine the average number of autonomous vehicles that will be traveling in the opposite direction as vehicle 500 for the travel path and time of travel along 540A. Computing system 560 can also predict the average number of other vehicles that could be used to send travel instructions before the vehicles enter area 520. The other vehicles can use V2V communication to send instructions from central management system 550 to vehicle 500 once the other vehicles are within proximity of vehicle 500.

Using a map database, computing system 560 can identify the length of route 540A to ensure a continuous connection to a vehicle through the first communication network and then using V2V communications. Computing system 560 can assess the vehicle ecosystem by identifying the number of vehicles that are required to create a V2V string through area 520. Computing system 560 may determine whether the number of vehicles in area 520 along route 540A is not sufficient to create a seamless V2V network. Computing system 560 may also determine whether vehicle 500 will be able to communicate with computing system 560 through the V2V network. Computing system 560 can determine whether route 540A has multiple lanes and whether vehicles are running in multiple lanes, such that repositioning the vehicles could create a better V2V network. Computing system 560 can determine the number of other vehicles on road 530A based on the position of vehicle 500, and once the other vehicles are creating a chain and approach to vehicle 500, then vehicle 500 can also communicate with computing system 560. Thus, by repositioning the other vehicles, computing system 560 can make driving decisions with vehicle in a collaborative manner.

Computing system 560 may select a different route in response to determining that route 540A has frequent route changes, a predicted network outage area, and/or not enough other vehicles on road 530B to create a V2V network to communicate with vehicle 500. Computing system 560 may instruct vehicle 500 to switch to a different route when vehicle 500 is already in area 520. Computing system 560 can cause a transmitter to transmit new travel instructions for vehicle 500 to other vehicles approaching vehicle 500 from an opposite direction on road 530A. Computing system 560 can cause a transmitter to transmit instructions to an intermediary vehicle that is not currently inside area 520. Once the intermediary vehicle is within proximity of vehicle 500, the intermediary vehicle can transmit data such as a route change using V2V communication through the second communication network.

Vehicle 500 can communicate with computing system 560 even while vehicle 500 is located in area 520 where the first communication network is not available. Vehicle 500 can transmit data such as coordinates and vehicle data to computing system 560. Vehicle 500 can transmit the data using V2V communication to an intermediary vehicle traveling in the opposite direction. The intermediary vehicle can transmit the data to computing system 560 once within the intermediary vehicle has network availability with the first communication network. Computing system 560 may be configured to determine another route for vehicle 500 where the first communication network will be available to vehicle 500. Computing system 560 can cause a transmitter to transmit signal 570 to an intermediary vehicle with instructions to communicate to vehicle 500 to travel on route 540B.

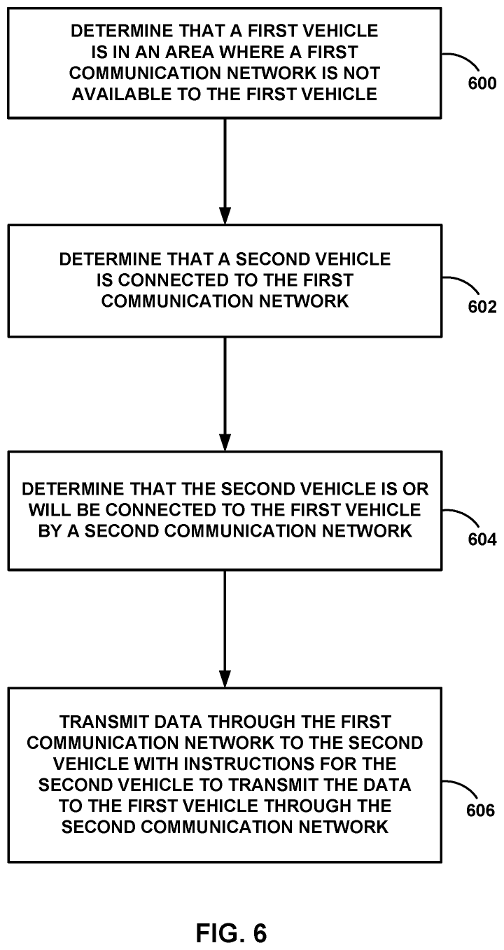

FIG. 6 shows a flowchart for an example technique for transmitting to a vehicle in an area where a communication network is not available, in some examples of this disclosure. The technique of FIG. 6 is described with reference to computing system 160 of FIG. 1, although other devices and systems, such as computing system 560 shown in FIG. 5, may also perform similar techniques.

In the example of FIG. 6, computing system 160 determines that vehicle 100 is in area 120 where a first communication network is not available to vehicle 100 (600). Computing system 160 may determine that vehicle 100 is in area 120 based on data indicating that the vehicle 100 entered area 120 at a previous time and has not reconnected to the first communication network. Computing system 160 can determine that vehicle 100 is in area 120 based on data indicating the starting point, destination, and route of vehicle 100.

In the example of FIG. 6, computing system 160 determines that vehicle 110 is connected to the first communication network (602). Computing system 160 can determine that vehicle 110 is connected to the first communication network by transmitting a signal to vehicle 110 through the first communication network and receiving a responsive signal from vehicle 110 through the first communication network. The responsive signal transmitted by vehicle 110 may include information about the route and destination of vehicle 110.

In the example of FIG. 6, computing system 160 determines that vehicle 110 is or will be connected to vehicle 100 by a second communication network (604). Computing system 160 can determine that vehicles 100 and 110 will be connected by the second communication network in the future by determining that vehicles 100 and 110 are traveling in opposite directions 104 and 114 towards each other. In some examples, computing system 160 may not be able to directly determine the location and direction 104 of vehicle 100 because vehicle 100 cannot communicate with computing system 160 through the first communication network. In such instances, computing system 160 can determine the location and direction 104 of vehicle 100 based on data indicating the starting point, destination, and route of vehicle 100.

In the example of FIG. 6, computing system 160 causes a transmitter to transmit, through the first communication network, data to vehicle 110 with instructions for vehicle 110 to transmit the data to vehicle 100 through the second communication network (606). Central management system 150 may include a transceiver that can transmit signal 170, which encodes the data for vehicle 100 and the instructions for vehicle 110 to communicate the data to vehicle 100 through the second communication network. Signal 170 can include a second route determined by computing system 160 for vehicle 100, where the second route is not along road 130. Computing system 160 may have determined the second route where the first communication network is available to vehicle 100. Signal 170 may include instructions for vehicle 110 to transmit data to vehicle 100 to cause vehicle 100 to adopt the second route.

In examples in which the remote network connectivity between central management system 150 and vehicle 100 is not available or working properly, vehicle 100 can collaborate with vehicle 110 within proximity using local PAN connectivity. Vehicle 110 can communicate with remote central management system 150 for navigation and management instructions to relay to vehicle 100.

Central management system 150 can use V2V communication as an intermediary when the first communication network is not available to vehicle 100. Vehicle 110 can act as the intermediary to communicate with central management system 150 because the first communication network is available to vehicle 110 and V2V communication will be available when vehicle 110 approaches vehicle 100 and areas 102 and 112 overlap. Central management system 150 can cause a transmitter to transmit signal 170 including instructions to vehicle 110, which still has service through the first communication network. Vehicle 110 can transmit the data and/or instructions to vehicle 100 using V2V communication (e.g., the second communication network) even within area 120 where the first communication network is not available.

Computing system 160 may be configured to predict or determine in real-time whether there is a sufficient number of vehicles in area 120 to achieve the local network connectivity with other vehicles and communication interval with central management system 150. Vehicles approaching in opposite direction from vehicle 100 can deliver new instructions by communicating with vehicle 100, and vehicles that have passed vehicle 100 can send data to computing system 160 once those vehicles are beyond area 120.

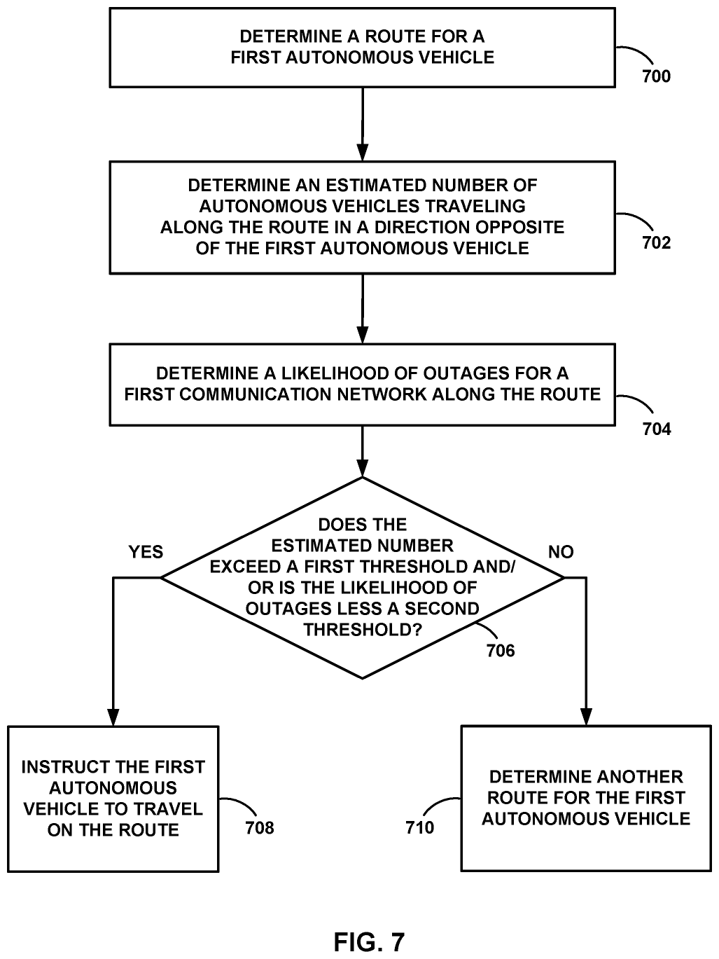

FIG. 7 shows a flowchart for an example technique for determining a route for an autonomous vehicle, in some examples of this disclosure. The technique of FIG. 7 is described with reference to computing system 560 of FIG. 5, although other devices and systems, such as computing system 160 shown in FIG. 1, may also perform similar techniques.

In the example of FIG. 7, computing system 560 determines route 540A for vehicle 500 (700). Vehicle 500 may be an autonomous vehicle that travels along a route selected by computing system 560.

In the example of FIG. 7, computing system 560 determines an estimated number of autonomous vehicles traveling along route 540A in a direction opposite of vehicle 500 (702). Computing system 560 can determine an estimated number of autonomous vehicles traveling along route 540A in the opposite direction at a particular time and a day that vehicle 500 will be traveling along route 540A. Computing system 560 can determine the time and the day that vehicle 500 will be traveling through area 520 because computing system 560 will instruct vehicle 500 when to depart a previous location. Computing system 560 can determine the estimated number of autonomous vehicles based on a set of historical data.

In the example of FIG. 7, computing system 560 determines a likelihood of outages for a first communication network along route 540A (704). Computing system 560 can determine the likelihood of outages based on historical data of outages in area 520, forecasted weather conditions, terrain, planned maintenance of infrastructure, and/or any other conditions.

In the example of FIG. 7, computing system 560 determines whether the estimated number of autonomous vehicles traveling along route 540A in the opposite direction exceeds a first threshold (706). Computing system 560 also determines whether the likelihood of outages along route 540A is less than a second threshold.

In the example of FIG. 7, responsive to determining that the estimated number exceeds the first threshold and the likelihood of outages is less than the second threshold, computing system 560 instructs vehicle 500 to travel on route 540A (708). Responsive to determining that the estimated number does not exceed the first threshold and the likelihood of outages is not less than the second threshold, computing system 560 determines route 540B for vehicle 500 (710). In some examples, computing system 560 uses an algorithm to determine a route based on weighting the estimated number and the likelihood of outages.

In some examples, computing system 560 determines that a first number of estimated vehicles traveling along route 540A is less than a threshold number. Responsive to this determination, computing system 560 instructs a first vehicle to travel along route 540B. Computing system 560 may then determine that a second number of estimated vehicles traveling along route 540A is greater than the threshold number. Responsive to this determination, computing system 560 instructs a second vehicle to travel along route 540A. The estimated number may be different for the first and second vehicles because of different times and days of travel.

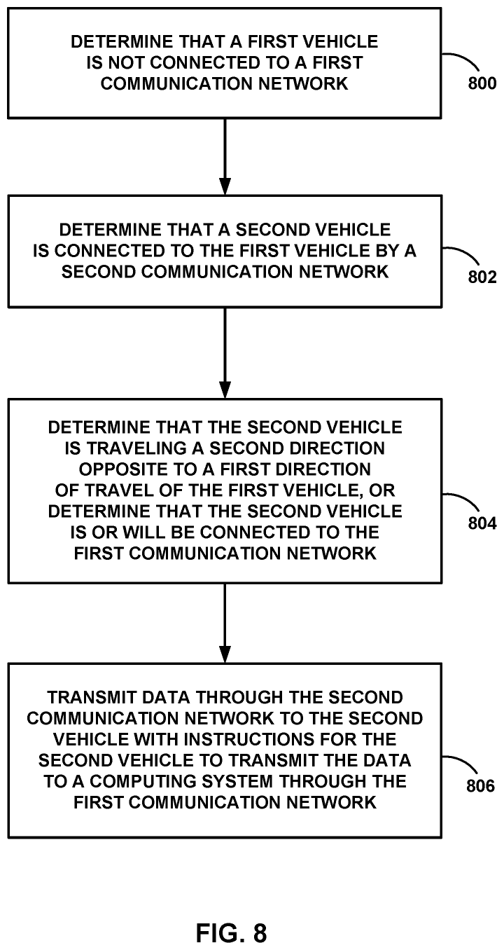

FIG. 8 shows a flowchart for an example technique for transmitting from a vehicle in an area where a communication network is not available to a remote computing system, in some examples of this disclosure. The technique of FIG. 8 is described with reference to vehicle 200 of FIG. 2, although other devices and systems may also perform similar techniques.

In the example of FIG. 8, processing circuitry 210 determines that vehicle 200 is not connected to a first communication network (800). Processing circuitry 210 can determine that there is damage to transceiver 220 that renders transceiver 220 unable to connect to the first communication network. Processing circuitry 210 can also determine that transceiver 220 has not received any messages through the first communication network for a particular time period.

In the example of FIG. 8, processing circuitry 210 determines that vehicle 280 is connected to vehicle 200 by a second communication network (802). Processing circuitry 210 can determine that vehicles 200 and 280 are connected by the second communication network in response to transceiver 220 receiving a message from vehicle 280 through the second communication network.

In the example of FIG. 8, processing circuitry 210 determines that vehicle 280 is traveling a second direction opposite to a first direction of travel of vehicle 200 (804). Processing circuitry 210 can determine the direction of travel of vehicle 280 by communicating with vehicle 280 through the second communication network. Transceiver 220 may receive a message from vehicle 280 indicating the location, direction of travel, route, destination, and/or any other information relating to vehicle 280.

Additionally or alternatively, processing circuitry 210 can determine that vehicle 280 is or will be connected to the first communication network. Processing circuitry 210 can determine that vehicle 280 is connected to the first communication network based on a message received from vehicle 280 indicating that vehicle 280 is currently connected to the first communication network. Processing circuitry 210 can determine that vehicle 280 will be connected to the first communication network in the future based on the location, direction of travel, route, destination, and/or any other information relating to vehicle 280. In some examples, processing circuitry 210 will transmit data to vehicle 280 for relay to central management system 270 in response to determining that vehicle 280 will be connected to the first communication network before vehicle 200 is connected to the first communication network.

In the example of FIG. 8, processing circuitry 210 causes transceiver 220 to transmit data through the second communication network to vehicle 280 with instructions for vehicle 280 to transmit the data to central management system 270 through the first communication network (806). Vehicle 280 may act as the intermediary vehicle and relay the data to central management system 270. In some examples, there are additional intermediary vehicles between vehicle 200 and central management system 270.

The example techniques described in this disclosure may be a computing device, a method, and/or a computer program product. The computer program product may include a computer readable storage medium (or media) having computer readable program instructions thereon for causing a processor to carry out aspects of one or more examples described in this disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of one or more examples described in this disclosure.

Aspects of the disclosure are described herein with reference to flowchart illustrations and/or block diagrams of methods, apparatus (systems), and computer program products according to one or more examples. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various examples of this disclosure. In this regard, each block in the flowchart or block diagrams may represent a module, segment, or portion of instructions, which comprises one or more executable instructions for implementing the specified logical function(s). In some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the present disclosure has been presented for purposes of illustration and description and is not intended to be exhaustive or limited to the disclosure in the form disclosed. Many modifications and variations will be understood by persons of ordinary skill in the art based on the concepts disclosed herein. The particular examples described were chosen and disclosed in order to explain the techniques described in the disclosure and example practical applications, and to enable others of ordinary skill in the art to understand the disclosure for various examples with various modifications as are suited to the particular use contemplated. The various examples described herein are within the scope of the following claims.

Various examples have been described. These and other examples are within the scope of the following claims.

What is claimed is:

1. A method comprising:
determining, by a computing system, that a first vehicle is in an area where a first communication network is not available to the first vehicle;
determining, by the computing system, that a second vehicle is connected to the first communication network;
determining, by the computing system, that the second vehicle is or will be connected to the first vehicle by a second communication network; and
transmitting, by a transmitter coupled to the computing system, data through the first communication network to the second vehicle with instructions for the second vehicle to transmit the data to the first vehicle through the second communication network.

2. The method of claim 1, wherein determining that the second vehicle will be connected to the first vehicle by the second communication network comprises:
determining that the first vehicle is traveling in a first direction; and
determining that the second vehicle is traveling in a second direction, the second direction being different than the first direction.

3. The method of claim 2,
wherein determining that the first vehicle is traveling in the first direction comprises determining that the first vehicle is traveling in the first direction on a road towards the second vehicle, and
wherein determining that the second vehicle is traveling in the second direction comprises determining that the second vehicle is traveling in the second direction on the road towards the first vehicle.

4. The method of claim 1, wherein determining that the second vehicle is or will be connected to the first vehicle by the second communication network comprises determining that the second vehicle is connected to the first vehicle by the second communication network, and wherein determining that the second vehicle is connected to the first vehicle by the second communication network comprises:
determining that the second vehicle is connected to a third vehicle by the second communication network, wherein the third vehicle is located between the first vehicle and the second vehicle; and
determining that the third vehicle is connected to the first vehicle by the second communication network.

5. The method of claim 4, wherein determining that the second vehicle is connected to the first vehicle by the second communication network comprises:
determining that the first vehicle is traveling on a road in a direction;
determining that the second vehicle is traveling on the road in the direction; and
determining that the third vehicle is traveling on the road in the direction.

6. The method of claim 1,
wherein the first communication network comprises a cellular network, and
wherein transmitting the data to the second vehicle through the first communication network comprises transmitting the data through the cellular network to the second vehicle.

7. The method of claim 1,
wherein the second communication network comprises a personal area network, and
wherein transmitting the data to the second vehicle with instructions for the second vehicle to transmit the data to the first vehicle through the second communication network comprises transmitting the data with instructions for the second vehicle to transmit the data to the first vehicle through the personal area network.

8. The method of claim 7, wherein transmitting the data to the second vehicle with instructions for the second vehicle to transmit the data to the first vehicle through the personal area network further comprises transmitting the data with instructions for the second vehicle to transmit the data to the first vehicle through a Bluetooth network or an infrared network.

9. The method of claim 1, further comprising determining a route for the first vehicle where the first communication network is available to the first vehicle,
wherein transmitting the data to the second vehicle comprises transmitting the data with instructions to the first vehicle to travel on the route.

10. The method of claim 1, further comprising determining a new destination for the first vehicle different than a previously determined destination for the first vehicle, wherein transmitting the data to the second vehicle comprises transmitting the data with instructions to the first vehicle to travel to the new destination.

11. The method of claim 1, wherein determining that the second vehicle is connected to the first communication network comprises determining that the second vehicle is not in the area where the first communication network is not available to the first vehicle.

12. A system comprising:
a transmitter; and
processing circuitry configured to:
determine that a first vehicle is in an area where a first communication network is not available to the first vehicle;
determine that a second vehicle is connected to the first communication network;
determine that the second vehicle is or will be connected to the first vehicle by a second communication network; and
cause the transmitter to transmit data to the second vehicle through the first communication network with instructions for the second vehicle to transmit the data to the first vehicle through the second communication network.

13. The system of claim 12, wherein the processing circuitry is configured to determine that the second vehicle will be connected to the first vehicle by the second communication network at least in part by:
determining that the first vehicle is traveling in a first direction; and
determining that the second vehicle is traveling in a second direction, the second direction being different than the first direction.

14. The system of claim 12, wherein the processing circuitry is configured to determine that the second vehicle is or will be connected to the first vehicle by the second communication network at least in part by determining that the second vehicle is connected to the first vehicle by the second communication network, and wherein the processing circuitry is configured to determine that the second vehicle is connected to the first vehicle by the second communication network at least in part by:
determining that the second vehicle is connected to a third vehicle by the second communication network, wherein the third vehicle is located between the first vehicle and the second vehicle; and
determining that the third vehicle is connected to the first vehicle by the second communication network.

15. The system of claim 12,
wherein the processing circuitry is further configured to determine a route for the first vehicle where the first communication network is available to the first vehicle,
wherein the processing circuitry is configured to cause the transmitter to transmit the data to the second vehicle at least in part by causing the transmitter to transmit the data with instructions to the first vehicle to travel on a route.

16. The system of claim 12,
wherein the processing circuitry is further configured to determine a new destination for the first vehicle different than a previously determined destination for the first vehicle, and
wherein the processing circuitry is configured to cause the transmitter to transmit the data to the second vehicle at least in part by causing the transmitter to transmit the data with instructions to the first vehicle to travel to the new destination.

17. A computer-readable medium comprising instructions for causing at least one programmable processor of a computing device to:
determine that a first vehicle is in an area where a first communication network is not available to the first vehicle;
determine that a second vehicle is connected to the first communication network;
determine that the second vehicle is or will be connected to the first vehicle by a second communication network; and
cause a transmitter to transmit data to the second vehicle through the first communication network with instructions for the second vehicle to transmit the data to the first vehicle through the second communication network.

18. The computer-readable medium of claim 17, wherein the instructions to determine that the second vehicle will be connected to the first vehicle by the second communication network comprise instructions to:
determine that the first vehicle is traveling in a first direction; and
determine that the second vehicle is traveling in a second direction, the second direction being different than the first direction.

19. The computer-readable medium of claim 17, wherein instructions to determine that the second vehicle is or will be connected to the first vehicle by the second communication network comprise instructions to determine that the second vehicle is connected to the first vehicle by the second communication network, and wherein the instructions to determine that the second vehicle is connected to the first vehicle by the second communication network comprise instructions to:
determine that the second vehicle is connected to a third vehicle by the second communication network, wherein the third vehicle is located between the first vehicle and the second vehicle; and
determine that the third vehicle is connected to the first vehicle by the second communication network.

20. The computer-readable medium of claim 17, further comprising instructions to determine a route for the first vehicle where the first communication network is available to the first vehicle,
wherein the instructions to cause the transmitter to transmit the data to the second vehicle comprise instructions to cause the transmitter to transmit the data with instructions to the first vehicle to travel on a route.
